(19) United States
(12) Patent Application Publication
(10) Pub. No.: US 2013/0263657 A1
(43) Pub. Date: Oct. 10, 2013

(54) APPARATUS AND METHOD FOR DETERMINING THE LIQUID LEVEL IN AN UN-MODIFIED TANK

(71) Applicant: FERRELLGAS, L.P. D/B/A BLUE RHINO, Winston-Salem, NC (US)

(72) Inventor: Paul J. Sides, Pittsburgh, PA (US)

(73) Assignee: Ferrellgas, L.P. d/b/a Blue Rhino, Winston-Salem, NC (US)

(21) Appl. No.: 13/859,087

(22) Filed: Apr. 9, 2013

Related U.S. Application Data
(60) Provisional application No. 61/621,964, filed on Apr. 9, 2012.

(51) Int. Cl. G01F 23/296

(52) U.S. Cl. CPC G01F 23/296
USPC 73/290 V

(57) ABSTRACT

A method for determining the level of fuel in tanks otherwise un-modified is provided. The method is based on the variation of the acoustic frequency response of the tank in the sonic range with the fuel level in the tank. In a preferred embodiment, the tank is a reservoir for propane used as fuel for preparing food. The operator, such as a homeowner, attaches the tank to his/her grill. The operator engages the proposed new art by tapping the tank and receiving the acoustic signal emanating from the tank with a microphone such as one embedded in a smartphone. The smartphone examines a cluster of peaks in the sonic frequency spectrum between 0 Hz and 20 kHz. By capturing the frequency of the first large peak above 900 Hz in the frequency spectrum, the smartphone converts the frequency into an estimate of the amount of fuel remaining in the tank.

### CROSS-REFERENCE TO RELATED APPLICATIONS

This application claims priority to U.S. Provisional Patent Application Ser. No. 61/621,964, filed Apr. 9, 2012, entitled “A method for determination of the liquid level in an un-modified tank,” the entirety of which is incorporated herein by reference.

### FIELD

The proposed invention is an apparatus and a method for determining the liquid level in a fuel tank by monitoring the resonant sonic frequency response of the fuel tank to an impulse of force applied briefly to the exterior of the tank. The present invention is directed to a need for convenient determination of the fuel level in a propane tank used for outdoor grilling of food. The invention does not require modification of the tank and is non-invasive. The impulse of force is provided by a tap on the tank's exterior.

### BACKGROUND

There are many ways of determining the level of a liquid in a container such as a tank. If the container is transparent or if the cover can be removed easily, visual inspection suffices. If the container is not transparent, some art must be used. In the case of oil in a crankcase, a dipstick is used. The related art of determining the liquid level in a tank often requires modification of the tank in some form or fashion. The simplest example is a float such as commonly found in the tank associated with toilets. The float rides on top of the liquid because its air-filled cavity is buoyant. When the liquid level rises to a desired height, the float mechanism closes a valve to stop the filling. Another solution is to provide an ultrasonic transducer or other actuator affixed to the tank. The transducer provides sonic energy to the tank and a signal is received.

### BRIEF SUMMARY

The object of the proposed new art is to provide a method for an individual to assess the fuel level in a tank using a common personal electronic device without special knowledge and without modification of the tank. In a preferred embodiment of the present invention, the tank is a reservoir for propane used as fuel for preparing food. The typical tank has a nominal tare weight (TW) of 18 pounds and a capacity of 15 pounds of propane. An operator, such as a homeowner, attaches the tank to a grill. After using the grill for some time, the operator typically wants to know how much propane remains in the tank. In the present embodiment, the operator engages the proposed new art by tapping the tank and receiving the acoustic signal emanating from the tank with a handheld microphone, such as one embedded in a smartphone. The smartphone converts the time-based acoustic signal to a frequency-based spectrum and then examines a cluster of peaks in the sonic frequency spectrum between 0 Hz and 20 kHz. In a particular embodiment, by capturing the frequency of the first large peak above 900 Hz in the frequency spectrum, and by applying the art proposed herein, the smartphone converts the frequency into an estimate of the amount of fuel remaining in the tank.

An exemplary method of determining the fill level of fuel tanks that are un-modified by the user comprises exciting the tank mechanically, measuring the acoustic response of the tank in the sonic range 0-20KHz, converting the acoustic response from the time domain to the frequency domain, determining the fundamental frequency of oscillation of the tank wall, and converting that frequency into a number that indicates the amount of liquid remaining in the tank. In a preferred embodiment the tank has a nominal mass of 18 pounds (TW 18), contains propane, and the frequency range where the fundamental peak is located lies between 900 and 1200 Hz.

The above description is one example application. While there are countless other applications and types of tanks, each type of tank emanates a cluster of peaks in the frequency spectrum of the type described herein.

### BRIEF DESCRIPTION OF THE DRAWINGS

Reference will now be made to the accompanying drawings, where:

FIG. 1 is a drawing of the invention;

FIG. 2 is a graph showing the relationship between the fundamental frequency of oscillation of a glass and the level of liquid in the glass;

FIG. 3 is a full sonic frequency spectrum obtained by processing the acoustic signal from a microphone proximate to a TW18 propane tank, after tapping on the tank;

FIG. 4 is a detailed frequency spectrum in the vicinity of 1 kHz obtained by an acoustic sensor proximate to the tank after the same tank is tapped once when more propane is present, and once when less propane is present;

FIG. 5 is a graph showing the relationship between the mass of propane in the tank and the measured frequency as defined herein for two tanks designated “t2” and “t3” and showing the predicted mass as a function of frequency “t2 fit” and “t3 fit” for each tank with the aid of Equation 2 herein;

FIG. 6 is a photograph of a typical home-grilling propane tank.

FIG. 7 is a parity plot showing the correspondence between predicted and actual masses of propane in various different tanks using the method and apparatus described herein.

### DETAILED DESCRIPTION OF EMBODIMENTS OF THE INVENTION

A method for determining the level of fuel in tanks otherwise un-modified is provided. The method is based on the variation of the acoustic frequency response of the tank in the sonic range with the fuel level in the tank. In a preferred embodiment, the tank is a reservoir for propane used as fuel for preparing food. The operator, such as a homeowner, attaches the tank to his/her grill. After using the grill for some time, the operator typically wants to know how much propane remains in the tank. The operator engages the proposed new art by tapping the tank and receiving the acoustic signal emanating from the tank with a handheld microphone such as one embedded in a smartphone. The smartphone examines a cluster of peaks in the sonic frequency spectrum between 0 Hz and 20 kHz. By capturing the frequency of the first large peak typically in the range 900 Hz-1200 Hz in the frequency spectrum, hereinafter referred to as the measured frequency (measured frequency), the smartphone converts the measured frequency into an estimate of the amount of fuel remaining in the tank. As referred to herein, the “tank” may refer to a holding tank, a vessel, a container, or the like. The terms may be used interchangeably throughout.

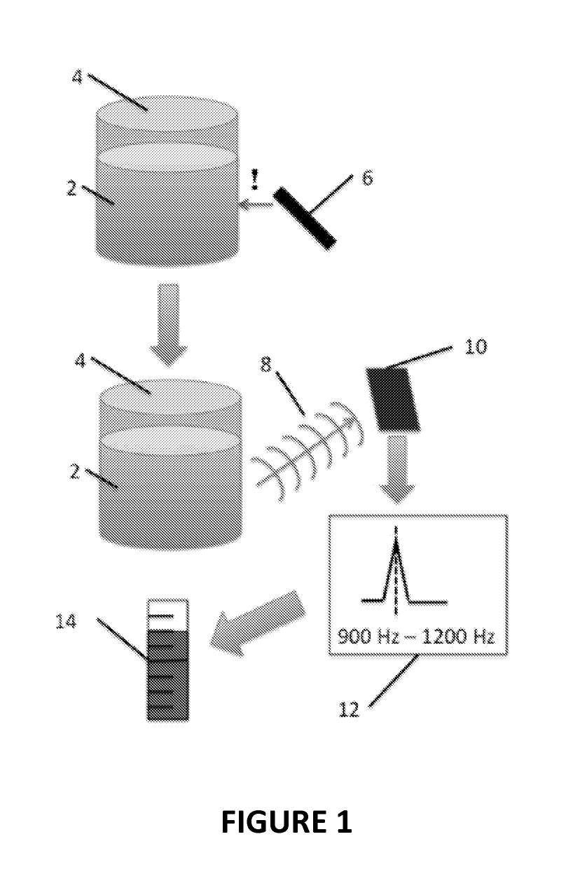

Referring to FIG. 1, a user of a liquid 2 stored in a tank 4 commonly wants to know how much liquid 2 remains in the tank 4. In the proposed art, the user taps an otherwise un-modified tank 4 with a solid object 6, which may or may not be a handheld combined sensor and computer (or a combination microphone/computer) 10, to excite the natural frequencies of the tank 4. The user positions the combination microphone/computer 10 near the tank 4 to capture the produced sound as an oscillating signal 8 in arbitrary units proportional to the intensity of the sound and as a function of time. The computing engine embedded in the combination microphone/computer 10, which in a preferred embodiment takes the form of a handheld device that incorporates both the microphone and computational capability (such as a smartphone), transforms the signal from the time domain to the frequency domain to produce a spectrum 12 and reports to the user an estimate 14 of the liquid level in the tank 4.

The sound of a vessel containing liquid 2 depends on the amount of liquid 2 in the vessel. For example, Jundt et al (Vibrational modes of partly filled wine glasses J Acoustical Soc Am 119 pp 3793ff (2006)) published a study of wineglass acoustics in which they gave an equation, presented below as Equation 1, relating the measured frequency of oscillation of a partially filled container to the frequency of the lowest frequency large peak typically in the range 900 Hz to 1200 Hz when empty, hereinafter referred to as the empty-tank frequency (empty-tank frequency).

$${ω}^{2} = \frac{{ω}_{o}^{2}}{1 + α {h}^{n}} \qquad Equation 1$$

ω: the measured frequency
ωₒ: the empty-tank frequency
α: a constant depending on the density of the liquid and the container
h: the height of the liquid in the container, also called the fill level
n: a constant depending on the container's shape

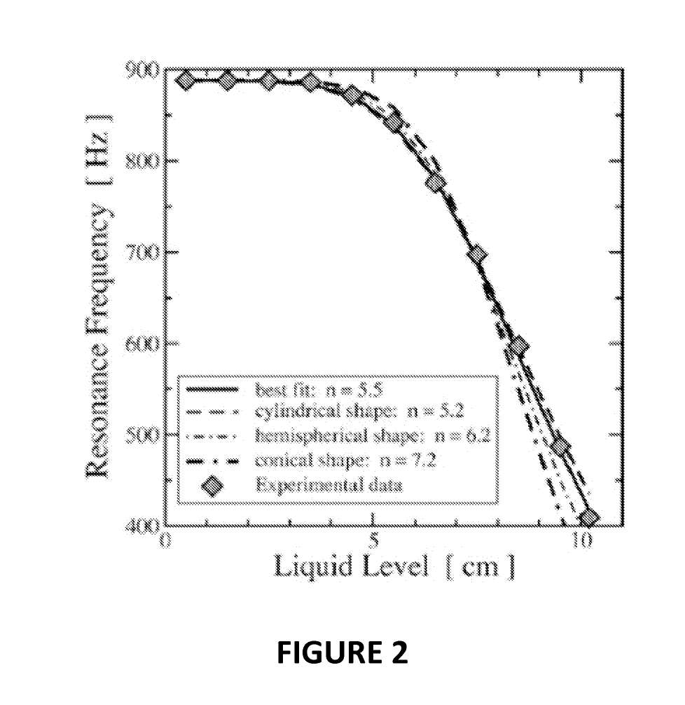

FIG. 2 is associated with the same Jundt et al article. FIG. 2 shows the measured frequency of oscillation of a glass as a function of the liquid level in the glass. FIG. 2 illustrates the basic properties of Equation 1. When the glass is more than half full (toward the right side of FIG. 2), the term in the denominator containing h is comparable to unity and the frequency of the oscillation strongly increases as the fill level decreases. As the fill level decreases below half full, the term containing h becomes small compared to unity and the frequency in FIG. 2 becomes weakly dependent on the fill level.

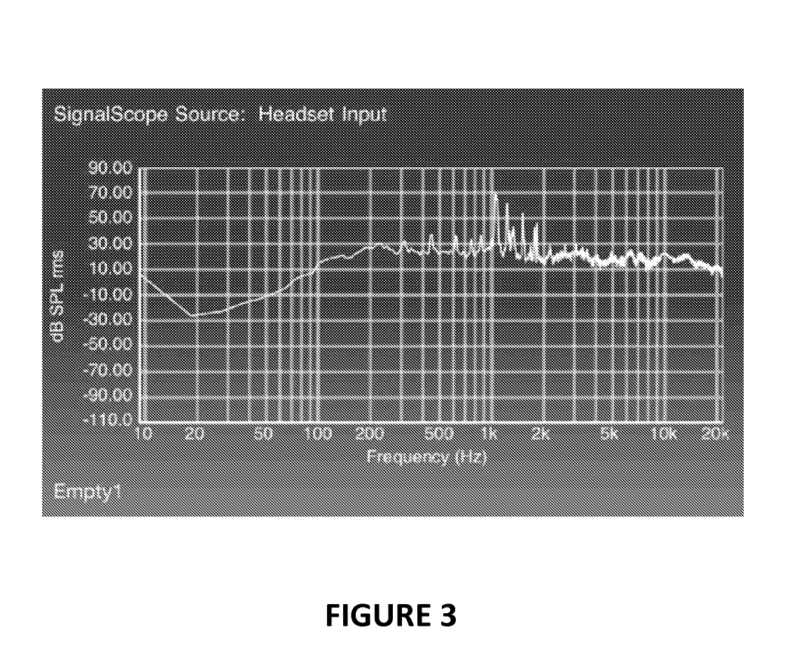

Referring to FIG. 3, one teaching of the proposed art is that a particular peak or a cluster of peaks in an acoustic spectrum of the tank 4 is related to the fill level of said tank 4. Furthermore, identification and exploitation of the peak(s) has practical utility. FIG. 3 is the acoustic spectrum of a propane container (tare weight=nominal 18 pounds) used in household outdoor grilling. This spectrum was obtained by positioning a mobile device (a smartphone, a tablet, a laptop, or the like) near a TW18 propane container and tapping the container while the appropriate software was activated on the mobile device. Note the cluster of large peaks at the frequencies between 1 kHz (1 k) and 2 kHz (2 k). Research has shown that these peaks are related to the fill level of propane in the container.

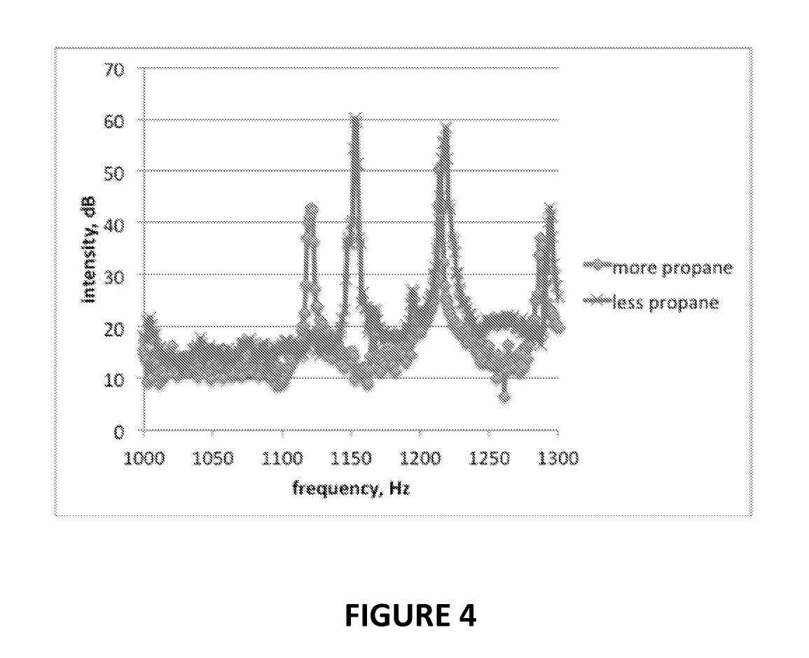

A detailed view of the frequency spectrum in the vicinity of 1 kHz for the same container at two different fill levels appears in FIG. 4. Here a peak at 1120 Hz is associated with the container with more propane in it, while a peak at 1150 Hz is associated with the container with less propane in it. The shift of the peak is a measure of the change of mass.

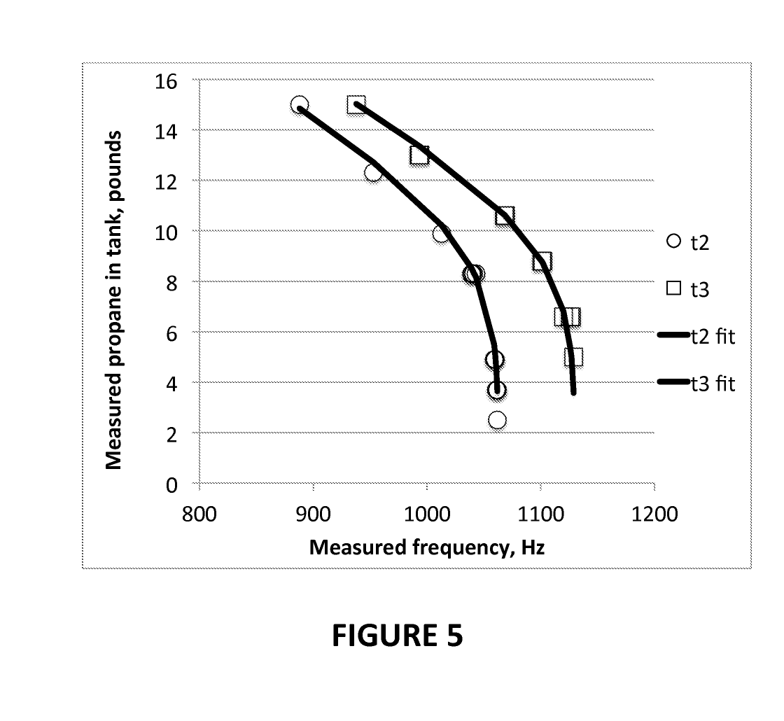

More results of research appear in FIG. 5. Shown in FIG. 5 are data points that connect the mass of propane in pounds remaining in two TW18 propane tanks as a function of measured frequency. This graph resembles the graph of FIG. 2 (with the axes reversed) because the connection between mass and frequency is strongest when the tank is full and becomes weaker as the mass of liquid in the tank decreases below half its original value.

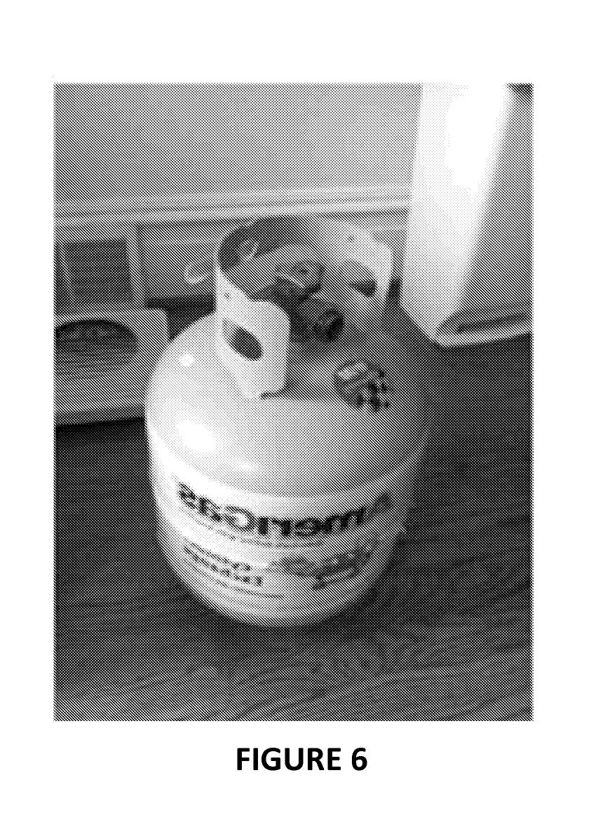

FIG. 6 depicts an exemplary propane tank 4 used in household outdoor grilling.

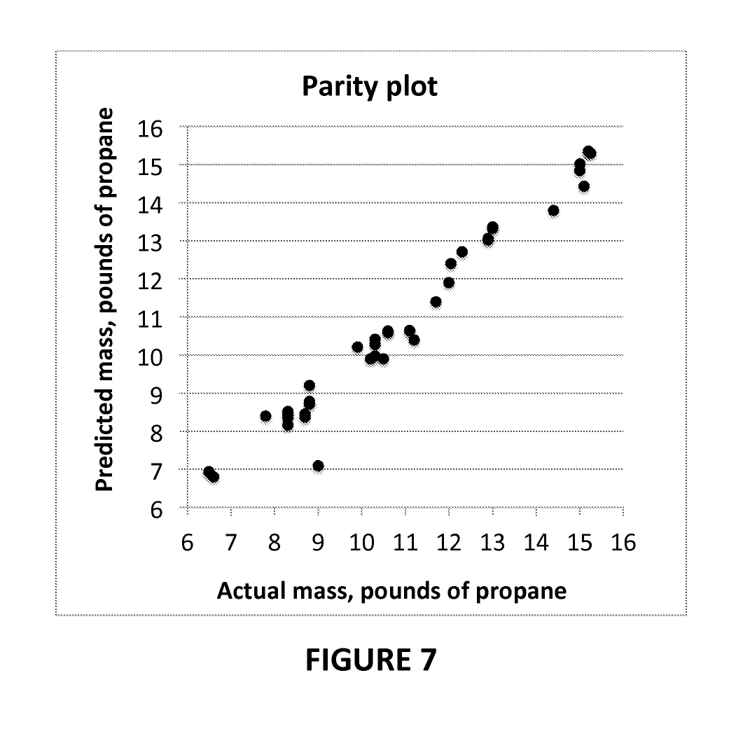

FIG. 7 shows a parity plot wherein the mass predicted using the method and apparatus described herein and the mass measured with a scale designed for such purpose are plotted one versus the other for several tanks The agreement is very good, showing the efficacy of the method.

If the user of the tank 4 wants to know the level of propane in his/her tank 4, the user repeats the elemental act of this experiment by tapping the tank 4 and positioning the handheld device 10 near the tank 4 to acquire the acoustic signal. From the graphs in FIG. 5, the user can easily determine whether the tank 4 is approximately half full, for any particular tank 4. For example, if the measured frequency is 1000 Hz for that tank 4, there are approximately 12 pounds of propane remaining for tank t2 and 14 pounds remaining for tank t3 in FIG. 5. FIG. 5 shows that the acoustic response of particular tanks obeys the form of Equation 1, but not all tanks respond identically.

Equation 1 is not convenient or very accurate for propane tanks Research has indicated that Equation 2, in which the logarithm of the mass of propane is expressed as an expansion of basis functions suggested by Equation 1, accurately describes the relationship among the mass of propane remaining (m, pounds), the measured frequency (ω, □□), and the empty-tank frequency (ωₒ, Hz) if the constants a, b, c, and d are determined by experiments.

$$log m = a ( log \frac{1 - \frac{{ω}^{2}}{{ω}_{0}^{2}}}{\frac{{ω}^{2}}{{ω}_{0}^{2}}} ) + b ( log \frac{1 - \frac{{ω}^{2}}{{ω}_{0}^{2}}}{\frac{{ω}^{2}}{{ω}_{0}^{2}}} ) + c ( log \frac{1 - \frac{{ω}^{2}}{{ω}_{0}^{2}}}{\frac{{ω}^{2}}{{ω}_{0}^{2}}} ) + d \qquad Equation 2$$

Further research has shown that the empty-tank frequency is different from tank to tank as made obvious by FIG. 5. For example, the tanks t2 and t3 of FIG. 5 exhibited different empty-tank frequencies. Accurate determination of the amount of propane remaining depends on knowing the empty-tank frequency of the particular tank.

There are two preferred methods for determining the empty-tank frequency. In a first preferred embodiment, the manufacturer of the tank or the vendor of fuel determines the empty-tank frequency and stamps it on the tank in a fashion analogous to the TW stamped on each tank or affixing it to the tank in some other fashion. This is a simple test for the manufacturer or vendor of such tanks to perform with the same methodology that the end user would employ. In this embodiment, the user can approach any tank so labeled, enter the empty-tank frequency, tap the tank, and receive an indication of the mass of propane remaining

In a second preferred embodiment, the user determines the empty-tank frequency when the mass of propane in the tank is known such as immediately after exchange of a tank or purchase of propane at a re-fill station. The user inputs the known mass of propane in the tank, either by indicating it is a new tank of a certain vendor or by direct input of the known mass, and then taps the tank. The handheld device solves Equation 2 for the only unknown parameter, the empty-tank frequency, the constants a, b, c, and d being known, incorporated into the handheld device as known constants, and applicable to any tank. In one embodiment, the values of the constants a, b, c, and d are 0.01722, 0.06956, 0.32607, and 1.28180. When these values are used, the mass is in pounds. In alternate embodiments, other values may be used for the constants.

If the empty-tank frequency is known or determined and incorporated into the calculation and if the measured frequency is accurate, Equation 2 will yield an estimated value of the propane mass m remaining in the tank. Practical considerations, however, limit the usefulness of the method embodied in Equation 2 to remaining masses of propane in TW 18 tanks above approximately 7 pounds. Below 7 pounds, as can be seen in FIG. 5, the mass of propane remaining becomes quite sensitive to the measured frequency. Small changes of a tank's acoustic response due to its dependence on ambient temperature, for example, can even yield measured frequencies slightly greater than the expected empty-tank frequency, which gives a meaningless result when used in Equation 2.

Two possibilities exist for improving the accuracy of the new art for smaller remaining masses of propane. Other features in the acoustic spectrum illustrated in FIG. 3 might yield information to one skilled in the art of acoustic analysis and alerted to the relevance of the frequency band cited in the proposed art to determining the remaining fuel level in a tank. In a preferred embodiment, one takes advantage of the dependence of the acoustic response of the tank on temperature and thermodynamics to determine the remaining mass of propane. In this preferred embodiment, the user taps the tank and obtains the measured frequency. The user then operates the grill for some period of time, during which the adiabatic expansion of the propane inside the tank, which forces fuel vapor out through the burners, cools the tank according to known laws of thermodynamics. The user again taps the tank and the measured frequency is different from before. A person skilled in the art and alerted to this possibility can relate the change of frequency to the mass of propane remaining.

The essence of the invention is the nexus of using a smartphone or other handheld device to both receive the signal and process it, all without modification of the tank in any way. A secondary essence of the invention is that particular resonant sonic frequencies of fuel tanks are associated with the fill level of the tank and that handheld electronic devices not primarily intended for this use can be employed to find these frequencies in the proposed art. Further, the variation of these particular frequencies with fill level provides a basis for determining the fill level of the tank without modification of the tank. In a preferred embodiment, the frequency range is 900 Hz to 1200 Hz. It will be obvious to a person skilled in the art, once taught this method and alerted to this particular application, that other specific frequency ranges and their dependence on temperature as well as fill level might comprise related information that enhance the utility of the method. Indeed certain frequencies in the acoustic spectrum might even be invariant with fill level and can be used as points of reference or calibration frequencies, or the frequencies might be especially sensitive to temperature and fill level. Nothing in this description eliminates those frequencies and sensitivities from consideration in the proposed art. Likewise, excitations at specific frequencies, instead of a brief tap, might be advantageous. The key is that the tank will resonate at specific frequencies that comprise information about the quantity of liquid in the tank and that a common handheld device can both receive the signal and process the signal to produce useful information about the state of fuel (e.g., fill level) in the tank.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, a mobile device such as a mobile phone, a computer program product, and/or the like), as a method (including, for example, a computer-implemented process, and/or the like), or as any combination of the foregoing. Accordingly, embodiments of the present invention may take the form of an entirely method embodiment, an entirely software embodiment (including firmware, resident software, micro-code, stored procedures in a database, or the like), an entirely hardware embodiment, or an embodiment combining software and hardware aspects that may generally be referred to herein as an apparatus or as a system. Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

The various methods described herein may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions described herein.

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions described herein.

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps described herein. Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein

What is claimed is:

1. A method for determining an amount of liquid in a tank, the method comprising:
receiving an acoustic signal from a tank, wherein the acoustic signal is received in response to a mechanical excitation of the tank;
determining a measured frequency of the acoustic signal; and
determining an amount of liquid in the tank based on the measured frequency of the acoustic signal.

2. The method of claim 1, wherein the amount of liquid in the tank is greater than or equal to approximately seven pounds.

3. The method of claim 1, wherein the measured frequency depends on temperature changes that occur when a tank valve associated with the tank is or has been open and vapor is or has been flowing to burners associated with the tank.

4. The method of claim 1, wherein the liquid comprises propane.

5. An apparatus for determining an amount of liquid in a tank, the apparatus comprising:
a sensor for receiving an acoustic signal from a tank, wherein the acoustic signal is received in response to a mechanical excitation of the tank; and
a processor for:
determining a measured frequency of the acoustic signal; and
determining an amount of liquid in the tank based on the measured frequency of the acoustic signal.

6. A computer program product for determining an amount of liquid in a tank, the computer program product comprising:
a non-transitory computer-readable medium comprising a set of codes for causing a computer to:
initiate reception of an acoustic signal from a tank, wherein the acoustic signal is received in response to a mechanical excitation of the tank;
determine a measured frequency of the acoustic signal; and
determine an amount of liquid in the tank based on the measured frequency of the acoustic signal.
